(19) United States
(12) Patent Application Publication
(10) Pub. No.: US 2021/0220103 A1
(43) Pub. Date: Jul. 22, 2021

(54) BRUSH AND HEAD

(71) Applicant: KYOCERA Corporation, Kyoto (JP)

(72) Inventor: Tomoyoshi IKEDA, Yokohama-shi, Kanagawa (JP)

(73) Assignee: KYOCERA Corporation, Kyoto (JP)

(21) Appl. No.: 16/768,876

(22) PCT Filed: Nov. 6, 2019
(86) PCT No.: PCT/JP2019/043521

§ 371 Date: Jun. 1, 2020

(30) Foreign Application Priority Data
Nov. 26, 2018 (JP) 2018-220589

(51) Int. Cl. A61C 17/34; A61C 17/22

(52) U.S. Cl. CPC A61C 17/3481; A46B 13/02; A61C 17/222

(57) ABSTRACT

A brush according to the present disclosure includes a head and a body. The head includes a bristle extending in a first direction. The body includes an actuator configured to expand and contract in a second direction intersecting the first direction, a connection member configured to transmit a vibration of the actuator to the head, and a housing that accommodates the actuator. The connection member includes a leg fixed to the housing.

### CROSS REFERENCE TO RELATED APPLICATION

This application claims priority to and the benefit of Japanese Patent Application No. 2018-220589 filed on Nov. 26, 2018, the entire contents of which are incorporated herein by reference.

### TECHNICAL FIELD

The present disclosure relates to a brush and a head.

### BACKGROUND

For example, electric toothbrushes are on the market.

### CITATION LIST

### Patent Literature

PTL 1: JP-A-2003-61986

### SUMMARY

A brush according to the present disclosure includes a head and a body. The head includes a bristle extending in a first direction. The body includes an actuator configured to expand and contract in a second direction intersecting the first direction, a connection member configured to transmit a vibration of the actuator to the head, and a housing that accommodates the actuator. The connection member includes a leg fixed to the housing.

### BRIEF DESCRIPTION OF THE DRAWINGS

FIG. 1 is a cross-sectional diagram illustrating a first example configuration;

FIG. 2 is a block diagram according to an example;

FIG. 3 is a graph illustrating a frequency characteristic of a signal according to an example;

FIG. 4 is a cross-sectional diagram illustrating a second example configuration; and

FIG. 5 is a cross-sectional diagram illustrating a third example configuration.

### DETAILED DESCRIPTION

According to the present disclosure, a new brush can be provided.

Hereinafter, embodiments of the present disclosure will be described.

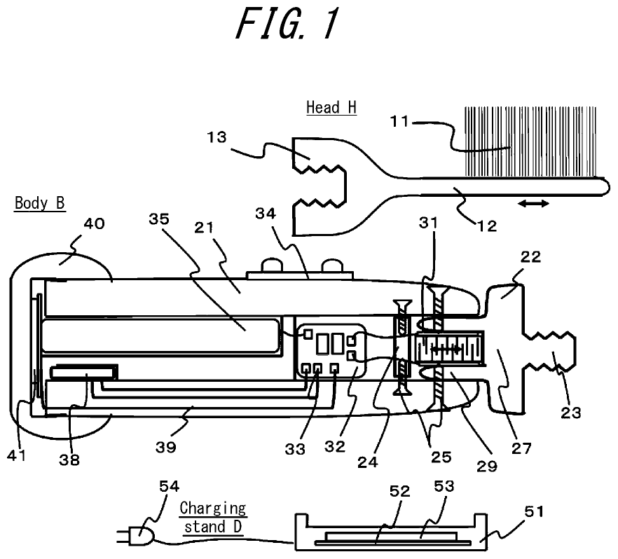

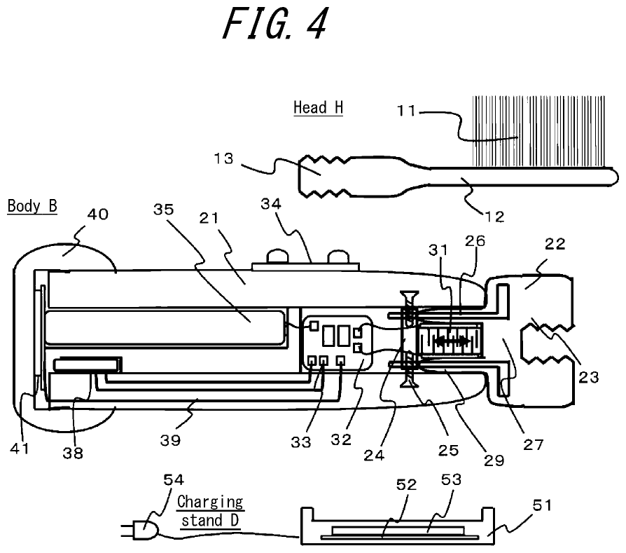

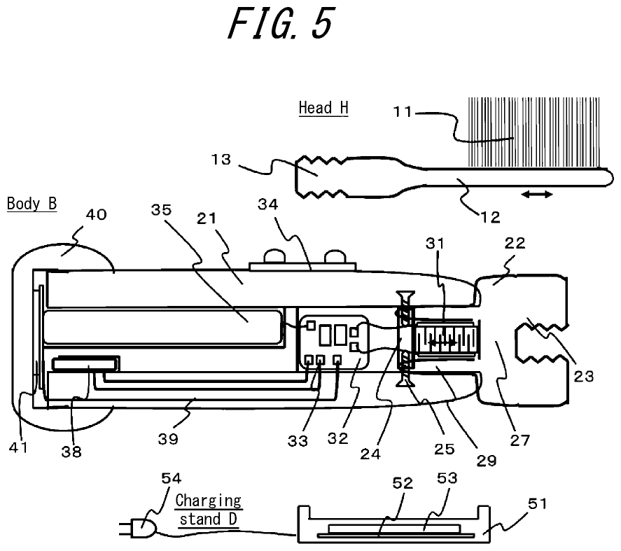

Each FIG. 1, FIG. 4, and FIG. 5 illustrates a cross-sectional diagram of a brush according to the respective embodiments. The brush will be described as a toothbrush, by way of example. However, the brush may be any brush other than a toothbrush.

For example, the toothbrush may roughly include three members. The first member is a head H provided with a bristle 11. The second member is a handle, i.e., a body B provided with a housing 21. The third member is a charging stand D, which is not necessary when, for example, the body B includes a dry cell but can be convenient when the body B includes a battery 35 which is rechargeable.

Each of the members will be described with reference to a configuration illustrated in FIG. 1. The head H includes the bristle 11, a stalk 12, and a fixing portion 13.

The bristle 11 includes, for example, a bundle of nylon hairs having an approximate diameter of, for example, 0.1 to 0.4 mm In the bristle 11, 15 to 20 nylon hairs having an approximate length of 30 to 40 mm are bundled into a bunch, folded at the middle, and then inserted into holes formed on the stalk 12, which will be described below. That is, after the insertion, each hole holds a bundle of approximately 30 to 40 hairs. After the insertion, the bristle 11 is trimmed into a uniform length. After the trimming, the length from the stalk 12 to the tip of the bristle 11 that is protruding from the stalk 12 is, for example, 7 mm to 13 mm. A trimmed surface may be a flat surface in which the bristle 11 has a uniform length or a saw-toothed jagged surface in which the bristle 11 has different lengths.

The stalk 12 may be made of a plastic material such as, for example, acryl, polycarbonate, or polypropylene. A surface of the stalk 12 is provided with approximately 12 to 36 holes having a diameter of approximately 1.3 mm to 2.1 mm in which the bristle 11 described above is to be embedded.

The bristle 11 is pushed into the holes. In the stalk 12, for example, the surface provided with the holes (referred to as a hole-side surface) may have a longitudinal length of 15 to 35 mm, a transverse length of 8 to 15 mm, and a thickness perpendicular to the surface of 2 to 10 mm including a thickness of an actuator 31.

The fixing portion 13 is provided at an end portion of the stalk 12 opposite to the side where the bristle 11 is embedded. The fixing portion 13 is to be fitted and fixed to a fixing portion 23 of the body B. The fixing portion 13 and the fixing portion 23 may be a combination of a male screw and a female screw. The fixing portion 13 and the fixing portion 23 may have the respective fitting portions formed in saw-tooth shapes in the cross-section to suppress disengagement therebetween after pushing insertion.

This configuration can enable replacement of the head H and suppress accidental detachment of the head H.

The body B may include the housing 21 serving as a handle, the actuator 31, a substrate 32 on which a control system and a booster circuit are mounted, an electrode pad 33, a cap 40, a battery 35, an operation unit 34, a connection member 22, and the like. The housing 21 has a cylindrical shape encloses a memory 38, the battery 35, the substrate 32, and the like therein. The housing 21 may have one end portion to which the connection member 22 is fixed to seal the inside of the housing 21. The cap 40 may be fixed to the other end portion of the housing 21 to seal the inside of the housing 21.

The housing 21 has a function to support the head H. The housing 21 encloses the substrate 32 and the battery 35. The housing 21 simply needs to have a strength not to break by grip of an adult in a normal use mode and may be made of a plastic material such as acrylic, polycarbonate, or polypropylene. The approximate length of the housing 21 is, for example, 10 cm to 25 cm. The approximate outer diameter of the cylindrical shape of the housing 21 is 1 to 3 cm.

The connection member 22 serves for a function to seal the inside of the housing 21 when a leg 29 is fixed to the housing 21 by screws 25. Openings formed on the connection member 22 into which the screws 25 are to be inserted may be covered and sealed by a resin after the insertion of the screws 25. Alternatively, the connection member 22 may be screwed into the housing 21 via a sealing member such as a washer. Needless to say, the housing 21 and the connection member 22 may be, for example, ultrasonically welded together or fixed together using an adhesive, other than being fixed by the screws 25.

The connection member 22 includes the fixing portion 23, a transmission portion 27, and the leg 29. The connection member 22 serves for a function to transmit a vibration generated by expansion and contraction of the actuator 31, which will be described later, in its stacking direction (as indicated by a double-headed arrow in FIG. 1) to the head H of the toothbrush. The connection member 22 may be made of, for example, a rubber material such as a silicone rubber. In the connection member 22, the leg 29 and the fixing portion 23 which are fixed by the screws 25 may be made of a somewhat hard rubber, a plastic material, a metal, or the like. The transmission portion 27 located between the actuator 31 and the fixing portion 23 may be made of a material softer than the material of the fixing portion 23 or the like such as, for example, rubber. A well-known double-molding technique or casting technique may be employed to produce the connection member 22. Needless to say, the entire connection member 22 including the fixing portion 23 and the transmission portion 27 may be made of the same material. The connection member 22 may have a hardness intermediate between a hardness required for the fixing portion 23 and a hardness required for the transmission portion 27. This configuration can simplify a manufacturing process of the connection member 22.

The fixing portion 13 of the head H is inserted into the fixing portion 23 of the connection member 22. As described above, the fixing portions 13 and 23 may be of either the screw-in type or the push-in type. Also, the male side and the female side may be interchanged. That is, the fixing portion 23 of the connection member 22 may be male and the fixing portion 13 of the head portion H may be female. Further, the hardness of rubber can be measured using, for example, a GS-719 series or a GS-720 series type A durometer manufactured by TECLOCK Co., Ltd, based on JIS K 6253 series: 2012.

The leg 29 of the connection member 22 is formed in a tubular shape surrounding the actuator 31. The leg 29 comes into contact with an inner wall surface of the housing 21 and thus realizes sealing of the inside of the housing 21. The leg 29 is in contact with the inner wall of the housing 21 and spaced apart from the actuator 31 to avoid hindering the vibration of the actuator 31.

A pedestal 24 is fixed to the housing 21 by the screws 25 within the housing 21. The holes formed on the housing 21 into which the screws 25 are to be inserted may be sealed by pouring a resin after the insertion of the screws 25 to ensure waterproofness. Alternatively, the pedestal 24 may be screwed to the housing 21 via a sealing member called an O-ring. The actuator 31 is arranged between the pedestal 24 and the transmission portion 27 of the connection member 22. The pedestal 24 and the transmission portion 27 are configured such that the expanding force of the actuator 31 at the time of expansion and contraction is directed to the transmission portion 27. That is, the pedestal 24 is fixed more firmly than the transmission portion 27, such that the actuator 31 easily expands to the transmission portion 27. To that end, the pedestal 24 has sufficient bending resistance and hardness as compared to the transmission portion 27 of the connection member 22. The pedestal 24 may be made of a metallic material such as SUS or brass. Alternatively, the pedestal 24 may be made of a hard plastic. Because the transmission portion 27 is configured to deform in accordance with the expansion and contraction of the actuator 31, the fixing portion 23 can vibrate the bristle 11 in a substantially same direction as an expanding and contracting direction of the actuator 31. Here, the substantially same direction means that an angle formed by the vibration direction of the bristle 11 (a direction of the primary back-and-forth movement of the bristle 11) with respect to the expanding and contracting direction of the piezoelectric element is 30 degrees or less. That is, the bristle 11 can reciprocate within a range of 90 degrees ±30 degrees with respect to the extending direction of the hairs of the bristle 11 and vibrate in a manner, for example, tracing the surface of teeth.

In the present embodiment, the actuator 31 is, for example, a laminated piezoelectric element. The laminated piezoelectric element is configured by alternately laminating dielectric members having piezoelectric characteristics such as PZT and internal electrodes having respective comb-like cross sections. The internal electrodes connected to the electrodes on a first side and the internal electrodes connected to the electrodes on a second side are alternately stacked.

The piezoelectric element has at least two electrodes. The piezoelectric element is electrically connected to the electrode on one side and the electrode on the other side from the substrate 32 via a wiring portion 39. The laminated piezoelectric element has a length of, for example, 5 mm to 120 mm in the stacking direction (which substantially coincides with the vibration direction of the piezoelectric element described above). The laminated piezoelectric element may have any shape in a cross-section in a direction perpendicular to the stacking direction including, for example, a substantially square shape in size of 2 mm to 15 mm or a columnar shape other than the square shape. The number of layers and the cross-sectional area of the laminated piezoelectric element are determined as appropriate.

A signal (a supply signal) is supplied to the laminated piezoelectric element from, for example, the substrate 32. In other words, in a case in which an AC voltage is applied from the substrate 32, upon application of a positive voltage to one of the electrodes, a negative voltage may be applied to the other electrode. On the other hand, upon application of a negative voltage to one of the electrodes of the laminated piezoelectric element, a positive voltage is applied to the other electrode. When a voltage is applied to each of the electrodes, polarization occurs in the dielectric, and the laminated piezoelectric element expands and contracts from a state in which a voltage is not applied. The expanding and contracting direction of the laminated piezoelectric element is substantially parallel to the stacking direction of the dielectrics and the internal electrodes. Alternatively, the expanding and contracting direction of the laminated piezoelectric element substantially coincides with the stacking direction of the dielectrics and the internal electrodes. The laminated piezoelectric element expands and contracts substantially along the stacking direction and thus offers an advantage that the vibration transmission efficiency in the expanding and contracting direction is improved.

Alternatively, when a positive voltage of, for example, 10 V is applied to one of the electrodes of the laminated piezoelectric element from the substrate 32, a voltage of 0 V may be applied to the other electrode. The voltage of the signal (the supply signal) applied to the laminated piezoelectric element by the booster circuit of a drive amplifier 37 may be, for example, 3 Vp-p to 50 Vp-p but is not limited to this range. The signal supplied to the actuator 31 via the wiring portion 39 and the like has a frequency characteristic as illustrated in FIG. 3, by way of example.

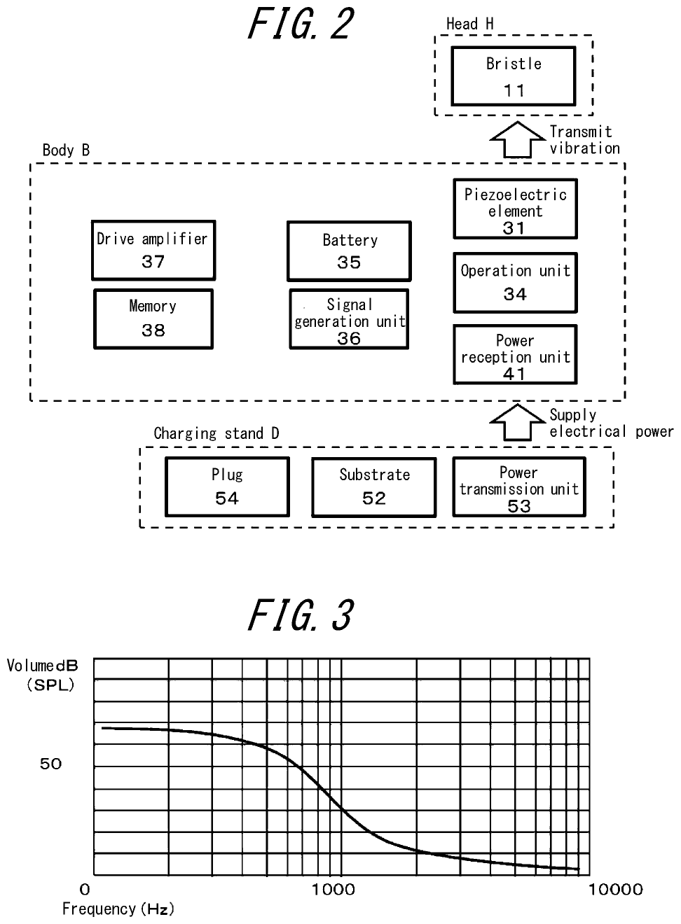

The substrate 32 is enclosed within the housing 21 having the cylindrical shape that realizes a waterproof structure. At least some of the functional units illustrated in the block diagram of FIG. 2 is mounted on the substrate 32. For example, a signal generation unit 36 and the drive amplifier 37 are mounted on the substrate 32.

The operation unit 34 may include a power switch (e.g., a button switch) for turning on and off the brush, a volume adjustment switch (e.g., a +button and a −button), and a switch for selecting a song or a voice of the contents. These switches are arranged on the outer surface of the housing 21. A user can operate each of the switches externally to the housing 21. For example, these switches may be provided under a waterproof sheet attached to the outer surface of the housing 21.

The battery 35 is enclosed within the housing 21. Electric power is supplied to the battery 35 from a power transmission portion 53 of the charging stand D via a power reception portion 41 using wireless power supply conforming to the non-contact power supply standard or the like. The battery 35 may be a dry battery. In this case, the body B and the charging stand D may omit the power transmission portion 53 and the power reception portion 41.

The cap 40 is attached to the end portion of the housing 21 on the opposite side from the connection member 22. The cap 40 seals the internal space in which the battery 35 and the substrate 32 are arranged. On the inner surface of the cap 40, a power reception portion 41 and a substrate equipped with a terminal and a circuit for transferring the electric power received by the power reception portion 41 to the battery 35 are provided.

A memory slot for accommodating the memory 38 is provided within the housing 21. The memory 38 may be a memory such as, for example, an SD card, or a unique flash memory. The cap 40 may be removable from the housing 21 to allow the user to mount or dismount the memory 38 or to replace the battery 35. Various sound sources may be stored in the memory 38. For example, the user can record desired contents such as music or a sound source as an audio signal in the memory 38 via a PC or a smartphone and insert the memory 38 containing the music or the sound source into a memory slot provided within the housing 21.

The charging stand D includes a housing 51, a substrate 52, a power transmission portion 53, and a plug 54. The housing 51 of the charging stand D has a main surface formed in a flat plate-like shape on which the body B can be mounted. A power transmission portion 53 is arranged on the main surface of the charging stand D and transmits electric power to the power reception portion 41 of the body B. The substrate 52 is arranged within the housing 51 and configured to convert electric power supplied from a commercial power grid via the plug 54 into electric power that can be transmitted conforming to the non-contact power supply.

Next, an example illustrated in FIG. 2 will be described including an electrical connecting relation such as the circuit configuration.

The charging stand D includes a plug 54 connected to a commercial power grid of, for example, 100 V, 1.5 A, and 50/60 Hz. The electric power supplied from the plug 54 is converted into a voltage and a current conforming to the non-contact charging standard through the circuit mounted on the substrate 52 and then transmitted to the power transmission portion 53.

The electric power from the power transmission portion 53 is stored in the battery 35 via the power reception portion 41.

The body B includes the piezoelectric element 31, the operation unit 34, the battery 35, the signal generation unit 36, the drive amplifier 37, the memory 38, the power reception portion 41, and the like.

The operation unit 34 may include a switching circuit for turning on and off the brush and a volume adjustment circuit. The operation unit 34 may further include a music selection switching circuit.

The battery 35 may include a charging circuit and an anti-overcharge circuit. The battery 35 may further include a thermistor.

The memory 38 stores an audio signal or the like for driving the piezoelectric element 31. In particular, the memory 38 stores an audio signal in a predetermined frequency band within the audible range, i.e., a non-discrete signal in a frequency within the audible range of 20 kHz or less, in other words, a signal having a continuous spread. Such a non-discrete signal is measured by procedures (1) to (4) described below and satisfies a condition (5).

(1) A speaker capable of outputting an air conduction sound of at least from 200 Hz to 10000 Hz is arranged at a location approximately 5 cm from an artificial ear of an IEC 60318 series HATS.
(2) A sound is continuously reproduced by the speaker using the sound signal mentioned above for at least 10 seconds or more.
(3) FFT (fast Fourier transform processing) is performed on a sound pressure input from a HATS microphone.
(4) In a graph illustrating a frequency characteristic of an output value after performing the FFT, provided that the output value is expressed by frequency F (Hz) =1 x n: (n is an integer of 200 to 10000),
(5) there must be 50 or more consecutive integers n as significant output values that exceed a floor noise by 15 dB (SPL) or more. That is, for example, significant output values are output for all of n=250, 251, 252, . . . , and 300. FIG. 3 illustrates an example.

The non-discrete signal is, for example, an analog or digital audio signal. The audio signal may include a music signal, human conversation data, a singing voice, or the like. Note that a signal that presents one frequency such as a signal called as a pure tone in the field of sound or a signal for driving a motor or the like at one rotation speed is not included in the non-discrete signal used herein.

Further, a signal made up of a plurality of pure tones alone is also discrete and thus is not included in the non-discrete signal. For example, a signal made up of a pure tone of 200 Hz and a pure tone of 10 kHz alone includes two ‘n’s (n=200, n=10000) and, simultaneously, these integers ‘n’ are not continuous in the above equation. Thus, this signal is not included in the non-discrete signal.

Further, the signal stored in the memory 38 may further include an ultrasonic signal corresponding to a frequency of, for example, 20 kHz or more to 100 kHz. The ultrasound signal may be discrete. For example, a signal of 50 kHz alone may be used to enhance the brushing effect by ultrasonic driving. In this case, a signal of an ultrasonic pure sound may be superimposed on a non-discrete signal within the audible range.

The signal stored in the memory 38 may be coded and compressed. The memory 38 for storing the signal may be a nonvolatile memory.

The signal generation unit 36 converts a signal recorded in the memory 38 into a supply signal to be supplied to the actuator 31 (the piezoelectric element 31). Here, the signal to be supplied to the actuator 31 (the piezoelectric element 31) will be referred to as the supply signal. In some cases, the signal recorded in the memory 38 may not need to be converted. The supply signal is subjected to enhancement of a predetermined frequency band or the like and then supplied to the actuator 31 (the piezoelectric element 31) via the drive amplifier 37.

For example, the supply signal also includes, among the signals recorded in the memory 38 described above, a signal that is continuous within a predetermined range as frequency characteristics, that is, a signal that is non-discrete within a predetermined range, in a manner similar to the non-discrete signal. For example, the signal generation unit 36 may generate an enhanced signal in which the frequency characteristic from 200 Hz to 400 Hz alone is enhanced by approximately 20 dB as compared with the original audio signal stored in the memory 38, and use the enhanced signal as a supply signal. By locally increasing the power of the signal in the low frequency band in this manner, an improvement in the brushing effect is expected. The enhanced signal may be realized by performing enhancement correction (a signal generation process) to enhance a frequency band desired to be enhanced using an equalizer when the music signal output from the memory 38 is applied to the drive amplifier 37. Needless to say, a signal itself having the same frequency characteristic as the enhanced signal may be originally stored as an audio signal in the memory 38.

Next, an operation of the actuator 31 (the piezoelectric element 31) and the bristle 11 will be described. The actuator 31 (the piezoelectric element 31) generates a vibration to expand and contract in the stacking direction (indicated by the arrow in FIG. 1), in accordance with the supply signal passed through the drive amplifier 37. In accordance with the back and forth vibration of the transmission portion 27 along the expansion and contraction of the actuator 31 (the piezoelectric element 31), the bristle 11 of the head H vibrates back and forth (as indicated by the arrow in FIG. 1). The music is reproduced by repetition of the above vibration according to the supply signal. The toothbrush vibrating back and forth to the tune of the music transmits vibration to the teeth of the user via the bristle 11. As a result, the user can hear sounds from the teeth via bone conduction.

Note that a switch of the operation unit 34 may be operated to switch between a normal mode for driving based on a basic audio signal and an intense mode for intensifying the brushing. Further, the switch of the operation unit 34 may be operated to adjust the volume in both the normal mode and the enhancement mode.

When the operation unit 34 is operated to increase the volume in volume adjustment, a magnitude of the power supplied to the actuator 31 is changed such that the volume of the whole music increases regardless of a specific frequency.

Further, vibrations in various frequency bands may be obtained by changing the type of the basic signal, that is, by changing the contents such as music or a story. This enables the user to brush the teeth with vibrations matching the desired contents while listening to the desired contents by bone conduction via the teeth.

Further, the actuator 31 (the piezoelectric element 31) may vibrate in the ultrasonic band (20 kHz or more) in addition to the audible range (from 10 Hz to 20 kHz). For example, the actuator 31 (the piezoelectric element 31) may vibrate at around 50 kHz in addition to a continuous vibration within the audible range (from 10 Hz to 20 kHz). This enables ultrasonic vibration brushing. The signal for giving the ultrasonic vibration may be a pure tone signal or a discrete signal. Needless to say, the signal for giving the ultrasonic vibration may be a continuous or non-discrete signal.

Next, an example configuration 2 will be described with reference to FIG. 4. In particular, a difference from FIG. 1 will be mainly described. The example configuration 2 is different from the example configuration 1 illustrated in FIG. 1 in terms of that the connection member 22 includes a reinforcing member 26 that is provided by insert-molding within the leg 29 of the connection member 22. The reinforcing member 26 is formed in an L shape by bending, for example, a SUS or a sheet metal. When the connection member 22 is fixed to the housing 21, the housing 21 and the reinforcing member 26 are together fixed by the screws 25.

This facilitates the fixing of the connection member 22 to the housing 21 even when the connection member 22 is made of a soft material having the Shore hardness of approximately 30 to 70 based on Shore hardness 00 in accordance with the hardness of, for example, the transmission portion 27. Shore hardness 00, which is the hardness of rubber, can be measured using a durometer conforming to ASTM D 2240 standard such as, for example, GS-754G manufactured by TECLOCK Co., Ltd. Note that the reinforcing member 26 does not need to be provided in a region opposing the transmission portion 27 in the vibration direction of the piezoelectric element 31. In this case, for example, a reinforcing member 26 having an annular portion surrounding the transmission portion 27 and the fixing portion 23 while avoiding their regions may be used. Alternatively, two partial members obtained by simply bending rod-shaped metals in an L shape may be used as the reinforcing member 26. This can realize a configuration that secures the fixing to the housing 21 while avoiding hindering the transmission of a vibration of the transmission portion 27. Note that the reinforcing member 26 is not limited to be made of a metal but may be made of a hard plastic. In the connection member 22, a hard plastic may be integrally embedded in a soft rubber material or the like by the two-color molding technique.

Next, an example configuration 2 will be described with reference to FIG. 5. In particular, a difference from FIG. 1 will be mainly described. In this example, the leg 29 and the pedestal 24 are fixed to the housing 21 by the same screw 25. Thus, a structure of the body B can be simplified.

### REFERENCE SIGNS LIST

H head

B body

D charging stand

11 bristle

12 stalk

13 fixing portion

21 housing

22 connection member

23 fixing portion

24 pedestal

25 screw

26 reinforcing member

27 transmission portion

29 leg

31 actuator (piezoelectric element)

32 substrate

33 electrode pad

34 operation unit

35 battery

36 signal generation unit

37 drive amplifier

38 memory

39 wiring portion

40 cap

41 power reception portion

51 housing

52 substrate

53 power transmission portion

54 plug

1. A brush comprising:
a head that includes a bristle extending in a first direction; and
a body that includes an actuator configured to expand and contract in a second direction intersecting the first direction, a connection member configured to transmit a vibration of the actuator to the head, and a housing that accommodates the actuator,
wherein the connection member includes a leg fixed to the housing.

2. The brush according to claim 1,
wherein a signal for driving the actuator includes a signal generated from a non-discrete signal.

3. The brush according to claim 2,
wherein the non-discrete signal includes an audio signal.

4. The brush according to claim 1,
wherein the connection member includes a transmission portion configured to deform in accordance with expansion and contraction of the actuator.

5. The brush according to claim 4,
wherein the transmission portion of the connection member faces the actuator.

6. The brush according to claim 5,
wherein the body further includes a housing that includes a pedestal configured to fix a piezoelectric element; and
wherein the pedestal and the transmission portion press the piezoelectric element.

7. The brush according to claim 3,
wherein, when the actuator is being driven based on the audio signal, a bone conduction sound is generated upon the bristle coming into contact with a tooth of a user.

8. The brush according to claim 1,
wherein the head that includes the bristle is removable from the body.

9. The head included in the brush according to claim 1, wherein the head is replaceable with respect to the body.
